(19) United States
(12) Patent Application Publication
(10) Pub. No.: US 2005/0144785 A1
(43) Pub. Date: Jul. 7, 2005

(54) Shaving apparatus

(75) Inventors: Peter Bressler, Philadelphia, PA (US); David Schiff, Highland Park, NJ (US); Andrew Pennella, Stamford, CT (US)

Correspondence Address: Richard R Michaud;The Michaud-Duffy Group LLP, 306 Industrial Park Road, Suite 206, Middletown, CT, 06457, US

(73) Assignee: Eveready Battery Company, Inc., St. Louis, MO (US)

(21) Appl. No.: 10/746,189

(22) Filed: Dec. 24, 2003

(51) Int. Cl. B26B 19/44

(52) U.S. Cl. 30/41

(57) ABSTRACT

According to the present invention, a shaving apparatus includes a flexible bladder, a housing, and a handle. The handle includes an interior cavity, an exterior grip portion, and an actuator. The flexible bladder has a width and is operable to store flowable shaving aid material. The flexible bladder is at least partially disposed within the interior cavity of the handle. The housing includes at least one port that is in fluid communication with the contents of the flexible bladder. The drive mechanism is operable to draw the pinch roller toward a top end of the interior cavity, thereby decreasing the volume of the flexible bladder

### BACKGROUND OF THE INVENTION

1. Technical Field

The present invention relates to shaving apparatus in general, and to shaving apparatus having a mechanism for providing a flowable shaving aid material in particular.

2. Background Information

Numerous attempts have been made to combine a razor assembly with a mechanism for dispensing shaving aid material. Some prior art devices (e.g., U.S. Pat. Nos. 3,726,009 and 1,899,841) disclose a reservoir disposed in the handle of the device for storing shaving aid material. The shaving aid material is propelled from the reservoir to the head of the device through one or more passages extending therebetween. A problem with providing a reservoir within the handle is that it is often necessary to make the handle uncomfortably large to accommodate a desirable amount of shaving aid material. If the handle is kept to a reasonable size, the volume of shaving aid material provided is undesirably small. Another problem with a shaving device having a reservoir containing a liquid or gel material is leakage.

Therefore, it is desirable to provide a shaving apparatus that overcomes these known shortcomings in the prior art.

### DISCLOSURE OF THE INVENTION

According to the present invention, a shaving apparatus includes a flexible bladder, a housing, and a handle. The handle includes an interior cavity, an exterior grip portion, and an actuator. The flexible bladder has a width and is operable to store flowable shaving aid material. The flexible bladder is at least partially disposed within the interior cavity of the handle. The housing includes at least one port that is in fluid communication with the contents of the flexible bladder. The actuator includes a pinch roller, a support assembly and a drive mechanism. The pinch roller is proximate to, and extends substantially across the width, of the bladder. The drive mechanism is operable to draw the pinch roller toward the top end of the interior cavity, thereby decreasing the volume of the flexible bladder.

According to an aspect of the present invention, a replacement cartridge includes a back plate and the housing and the flexible bladder described above.

An advantage of the present invention is the that the shaving apparatus of the present invention is operable with a variety of non-solid shaving aid materials, such as, for example, liquids, creams, and gels.

Another advantage of the present invention is that shaving aid material can be applied from the present invention “on demand”.

These and other objects, features, and advantages of the present invention will become apparent in light of the detailed description of the present invention.

### BRIEF DESCRIPTION OF THE DRAWINGS

FIG. 1 is a diagrammatic view of a shaving apparatus of the present invention.

FIG. 2 is a sectional view of one embodiment of the shaving apparatus of the present invention with a partial section view of the flexible bladder.

FIG. 3 is an enlarged view of area “3” of FIG. 2 depicting a ratchet mechanism.

FIG. 4 is a diagrammatic view of a drive mechanism that utilizes a conveyor.

FIG. 5 is a diagrammatic view depicting the drive mechanism illustrated in FIG. 4 wherein the pinch roller is between the top end and the bottom end of the interior cavity.

FIG. 6 is sectional view of an embodiment of the shaving apparatus of the present invention including a cord.

FIG. 7 is a sectional view depicting the shaving apparatus of FIG. 6 wherein the pinch roller is between the top end and the bottom end of the interior cavity.

FIG. 8 is an exploded view of one embodiment of a replacement cartridge partially inserted into a handle.

FIG. 9 is a sectional view of one embodiment of a replacement cartridge partially inserted into a handle.

### DETAILED DESCRIPTION OF THE INVENTION

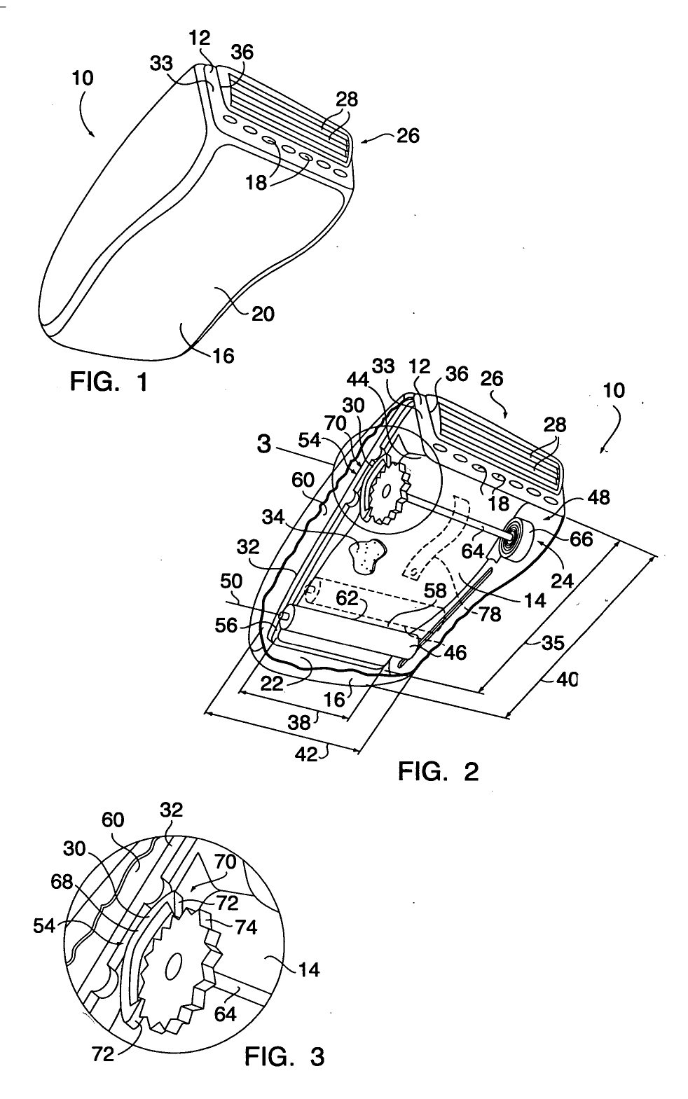

Referring to FIGS. 1-3, a shaving apparatus 10 includes a housing 12, a flexible bladder 14, and a handle 16. The housing 12 includes one or more ports 18 and the handle 16 includes an exterior grip portion 20, an interior cavity 22 and an actuator 24. In some embodiments, the shaving apparatus 10 also includes a razor cartridge 26.

The razor cartridge 26 includes one or more razor blades 28 and is attached fixedly, or pivotally to the housing 12 and/or the handle 16. In some embodiments, the razor cartridge 26 may also be coupled to a latch 30 (discussed infra.), as shown, for example, in FIGS. 2 and 3. A variety of different razor cartridges 26 can be used with the present shaving apparatus 10, including those that are intended to be disposable. Therefore, in some embodiments, various different replacement razor cartridges 26 may be used with the same handle 16 and/or housing 12. The present apparatus is not, therefore, limited to any particular type of razor cartridge 26.

The housing 12 includes one or more ports 18 positioned adjacent the razor cartridge 26. The housing 12 includes an exterior surface 33 that may be smooth, or textured. In some embodiments, the housing 12 may define an aperture 36 in which the razor cartridge 26 is positioned. The housing 12 is fixedly or pivotally attached to the handle 16. In some embodiments, the housing 12 may be coupled to the latch 30, the back plate 32 (discussed infra.) and/or the handle 16.

Referring to FIG. 2, the one or more ports 18 in the housing 12 are in fluid communication with the contents of the flexible bladder 14. Each port 18 is operable to allow a flowable shaving aid material 34 to pass therethrough. Typically, the size of each port 18 is determined by the type of shaving aid material disposed in the flexible bladder 14, the number of ports 18 located on the housing 12, and the desired rate at which the flowable shaving aid material is to be dispensed. The one or more ports 18 may be fore and/or aft the shaving cartridge 26 during normal use. Alternatively, in some embodiments, one port 18 may substantially surround the razor cartridge 26. For example, in embodiments where the razor cartridge 26 is positioned in a port 18 in the housing 12, the contents of the flexible bladder 14 may, in some cases, exit through the shaving cartridge 26, itself.

The flexible bladder 14 is operable to store a flowable shaving aid material and is disposed within the interior cavity 22 in the handle 16. The flexible bladder 14 may be made of any suitable flexible material and, has a height 36, width 38 and depth (not indicated). Preferably, the flexible bladder 14 when filled has a shape that is complimentary to the interior cavity 22 of the handle 16.

Examples of flowable shaving aid materials 34 include, but are not limited to, lubricating agents, drag reducing agents, depilatory agents, cleaning agents, medicinal agents, and the like, that enhance the shaving process. Common forms of flowable shaving aid materials 34 include liquids, creams, and gels.

The handle 16 includes an exterior grip portion 20, an interior cavity 22 and an actuator 24, as mentioned above. The exterior grip portion 20 of the handle 16 may be of any practical shape and size. Preferably, the exterior grip portion 20 is ergonomically contoured to allow it to be gripped comfortably by the user. The interior cavity 22 includes a height 40, width 42, and depth (not indicated) and is sized and shaped to receive the flexible bladder 14 and house the actuator 24. The interior cavity 22 includes an open end 44.

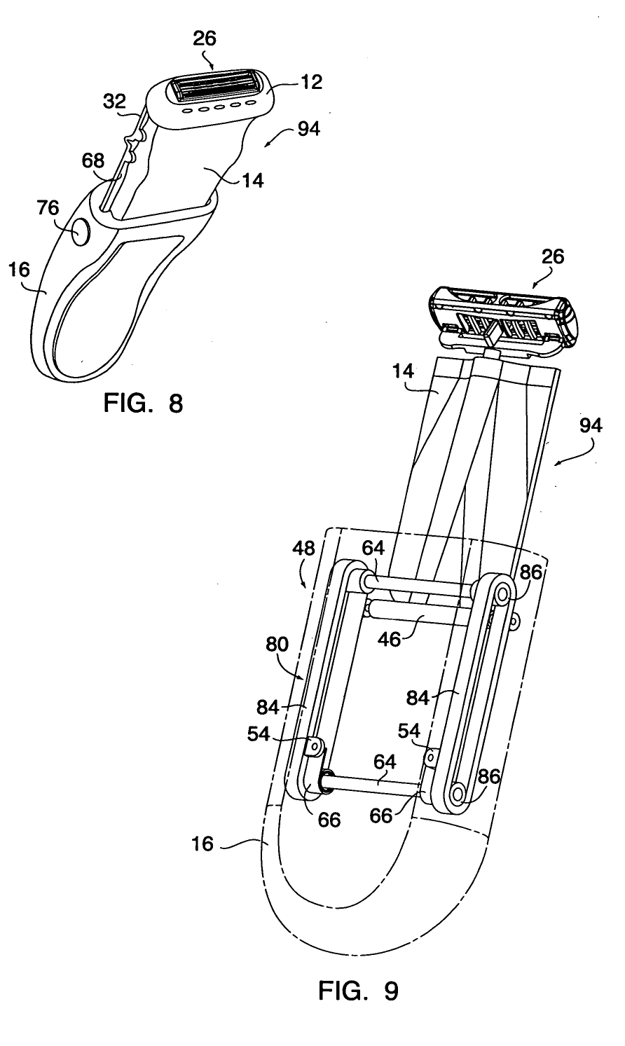

Referring now to FIGS. 2-7, the actuator 24 is disposed in the handle 16 and is operable to selectively decrease the volume of the flexible bladder 14. The actuator 24 decreasing the volume of the bladder 14 may, by itself, provide the requisite force to cause the exit of the shaving aid material disposed within the bladder 14. In some embodiments however, as will be described below, the force is provided completely or in part by the, movement of the razor cartridge 26 and/or the housing 12. The actuator 24 includes a pinch roller 46 and a drive mechanism 48 for moving the pinch roller 46 from a first position 50 to a second position 52. Preferably, the second position 52 is located near the open end 44 of the interior cavity 22 and the first position 50 is located further inside the interior cavity 22. The actuator 24 further includes a linkage 54 that enables the drive mechanism 48 to be incrementally applied, in some embodiments. In addition, a back plate 32 (see FIG. 8) may be disposed in the handle 16. The surface 56 of the back plate 32 adjacent the flexible bladder 14 may be flat or otherwise contoured. In addition, the back plate 32 may connect to the flexible bladder 14, in order to prevent the flexible bladder 14 from undesirably pulling, bunching, or folding up during operation. The back plate 32 may be attached to, for example, the handle 16, or the housing 12.

Referring back to FIG. 2, the pinch roller 46 is slidably mounted in the interior cavity 22 of the handle 16 such that the pinch roller 46 is adjacent, and extends across at least a portion of the width 38 of, the flexible bladder 14. Preferably, the pinch roller 46 extends across the entire width 38 of the flexible bladder 14. The pinch roller 46 is positioned in the handle 16 such that a gap 58 exists between the pinch roller 46 and either the back plate 32, or the interior cavity wall 60. In most embodiments, the gap 58 between the pinch roller 46 and the back plate 32 (see FIG. 8), or the interior cavity wall 60, is sized such that when the pinch roller 46 is moved toward the second position 52, the sides of the flexible bladder 14 are pinched together. In doing so, the contents of the flexible bladder 14 are forced to exit through the one or more ports 18. In a preferred embodiment, the magnitude of the gap 58 between the pinch roller 46 and the back plate 32, or interior cavity wall 60, is substantially the same size, regardless of the position of the pinch roller 46 between the first and second positions 50,52.

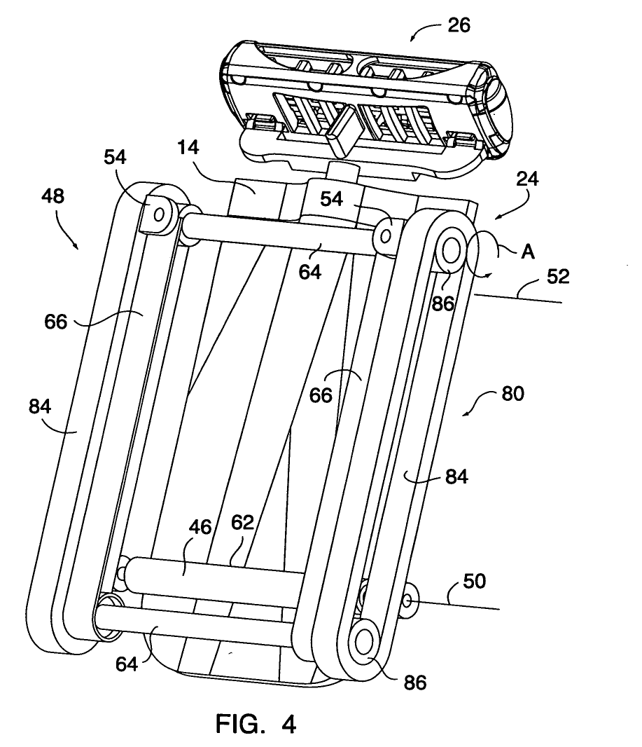

The surface 62 of the pinch roller 46 adjacent the flexible bladder 14 is curved to prevent the pinch roller 46 from undesirably pulling, bunching, or folding the material of the flexible bladder 14 when the pinch roller 14 is moved towards the second position 52. As shown, for example in FIG. 4, the pinch roller 46 may be cylindrical.

In the embodiment shown in FIG. 2, the drive mechanism 48 includes a shaft 64 and a power spring 66. The drive mechanism 48 is operable to selectively move the pinch roller 46 toward the second position 52 (as shown in FIGS. 4-7).

The shaft 64 of the drive mechanism 48 is rotatably mounted in the handle 16. In some embodiments, the drive mechanism 48 is mounted to the back plate 32, the handle 16, or the housing 12. In some embodiments, the shaft 64 extends at least partially across the width 38 of the flexible bladder 14. However, it is preferable that the shaft 64 extends across the entire width 38 of the flexible bladder 14, as shown in FIG. 2.

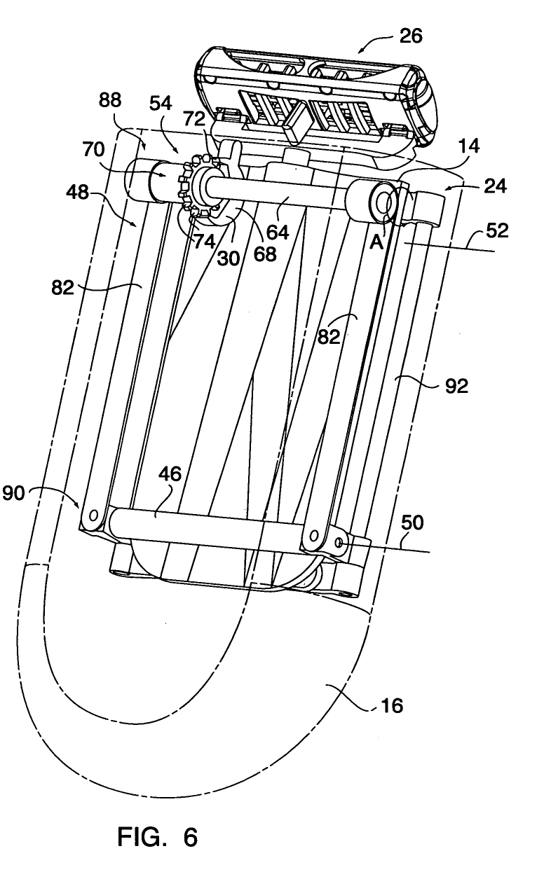

Referring to FIGS. 4 and 6, the power spring 66 is operable to impart sufficient torsional force on the shaft 64 to cause the shaft 64 to rotate in a first direction (indicated by arrow “A”). In some embodiments, such as those shown in FIGS. 4-7, the drive mechanism includes two power springs 66. However, the present invention should not be considered limited to using a spring to apply a torsional force on the shaft 64. Potential energy devices, other than springs, may also be used without departing from the spirit of the present invention.

Referring to FIGS. 2 and 3, the linkage 54 includes a latch 68 and a gear 69. The gear 69 is attached to the shaft 64. The latch 68 is operable to selectively move between an opened position (not shown) and a closed position 70 relative to the gear 69. In the closed position 70, the latch 68 is engaged with the shaft 64 via the gear 69 to counteract the torsional force of the power spring 66, thereby substantially preventing the shaft 64 from rotating in either direction. In the opened position, the latch 68 is disengaged from the gear 69, thereby permitting the power spring 66 to cause the shaft 64 to rotate. The latch 68 and gear 69 combination permit the shaft 64 to rotate incrementally each time the latch 68 is moved to the opened position.

In some embodiments, the latch 68 is selectively movable from the closed position 70 to the opened position, and vice versa, from a position external to the handle 16. For example, depressable buttons 76, as shown in FIG. 8, or the like, located outside the handle 16 may be coupled to the latch 68 that are operable to move the latch 68 between the opened position and closed position 70.

In other embodiments, the latch 68 is operable to move between an open position and a closed position 70 in connection with movement of the housing 12 and/or the razor cartridge 26. In these embodiments, the movement (e.g., pivoting) of the housing 12 and/or the razor cartridge 26 causes, by itself or in combination with the actuator 24, the exit of shaving aid material disposed within the bladder 14.

When not in use, a biasing member 78, such as a leaf spring (as shown in FIG. 3), is typically utilized to tend to force the latch 68 and shaft 64, to move toward one another and into the closed position 70. However, sufficient force applied to the housing 12 and/or the razor cartridge 26, which is coupled to the latch 68 or the shaft 64, will tend to move the latch 68 and shaft 64 away from one another and into an opened position. Once the force on the housing 12 and/or the razor cartridge 26 is released, the biasing member 78 tends to cause the latch 68 and the shaft 64 to return to the closed position 70.

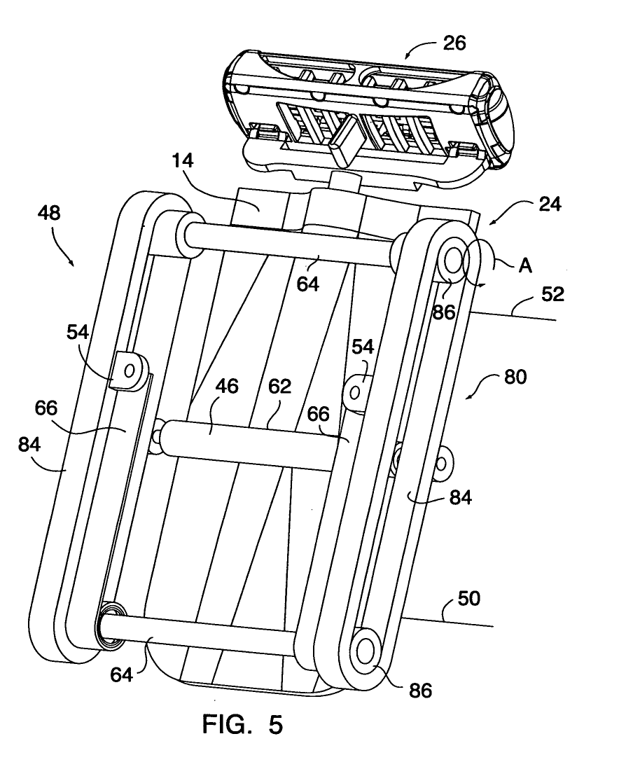

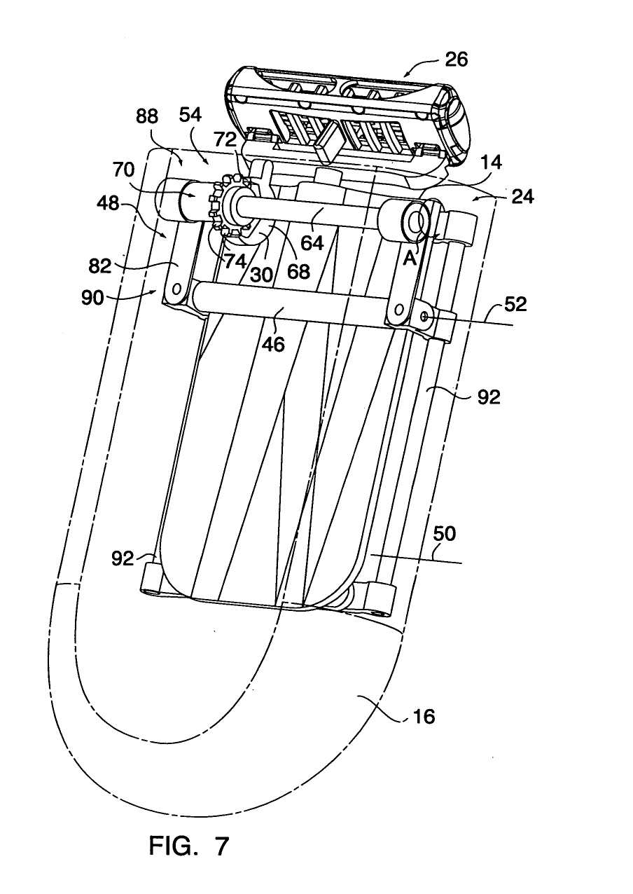

The shaft 64 of the drive mechanism 48 is coupled to the pinch roller 46. In some embodiments, the shaft 64 is coupled to the pinch roller 48 via a conveyor 80, as shown in FIGS. 4 and 5. In other embodiments, the shaft 64 is coupled to the pinch roller 46 via a cord 82, as shown in FIGS. 6 and 7.

Referring to FIGS. 4 and 5, the conveyor 80 includes at least one continuous belt 84 looped around the shaft 64 and a pulley 86 positioned in the handle 16, near the first position 50. As shown in the embodiments of FIGS. 4 and 5, two conveyors 80 are utilized in some embodiments. Preferably, the continuous belt 84 is substantially taut around the shaft 64 and the pulley 86 in order to prevent the continuous belt 84 from undesirably disconnecting during use. The pinch roller 46 is attached to the continuous belt 84 at a point between the pulley 86 and the shaft 64 such that the pinch roller 46 moves towards the second position 52 when the shaft 64 rotates in the first direction (“A”) (as indicated in FIG. 4). Typically, the pulley(s) 86 are rotatably mounted to the handle 16, or back plate 32.

Referring now to FIGS. 6 and 7, as mentioned above, the shaft 64 is connected to the pinch roller 46 via a cord 82 in some embodiments. A first end 88 of the cord 82 is connected to the shaft 64 and a second end 90 of the cord 82 is connected to the pinch roller 46. The cord 82 is operable to wrap around the shaft 64 as the shaft 64 turns in the first direction (“A”), thereby forcing the pinch roller 46 to move towards the second position 52. Preferably, the cord 82 is substantially flat to facilitate wrapping over itself on the shaft 64 multiple times. In some embodiments, the cord 82 may also act as the power spring 66, providing a torsional force on the shaft 64 as it tends to coil around the shaft 64. In these embodiments, the pinch roller 46 may be slidably mounted to at least one support post 92 disposed in the handle 16 for stability. The support posts 92 may, for example, be mounted to the housing 12, the back plate 32, or the handle 16, itself.

Referring to FIGS. 8 and 9, a replacement cartridge 94 includes the housing 12 and the flexible bladder 14 described above. In some embodiments, the replacement cartridge 94 may also include one or more of a latch 68, a razor cartridge 26 and a back plate 32. The replacement cartridge 94 described above is insertable into a handle 16.

In operation, the user causes the latch 68 to move from the closed position 70 to the opened position. In some embodiments, the user must press an external depressable button 76. In other embodiments, the user simply applies pressure to the housing 12 and/or the razor cartridge 26. When the latch 68 moves to the opened position, the power spring 66 causes the shaft 64 to turn. As the shaft 64 turns, the pinch roller 46 moves towards the second position 52. As the pinch roller 46 moves, it pinches the flexible bladder 14 between the pinch roller 46 and either the back plate 32 or the interior cavity wall 60, thereby decreasing the volume of the flexible bladder 14. The decrease in volume of the flexible bladder 14, completely or in part, causes the contents of the flexible bladder 14 (i.e., the flowable shaving aid material) to exit through the one or more ports 18 in the housing 12. Therefore, the flowable shaving aid material 34 is dispensed onto the surface being shaved adjacent the razor cartridge 26 before, or while, the razor blade(s) 28 shave the undesired hair.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A shaving apparatus, comprising:
a flexible bladder operable to store flowable shaving aid material, the flexible bladder having a width and being disposed within the interior cavity of the handle;
a housing having at least one port, the at least one port being in fluid communication with the contents of the flexible bladder;
a handle having an interior cavity, an exterior grip portion, and an actuator, the actuator including a pinch roller, a support assembly and a drive mechanism;
wherein the pinch roller being proximate to, and extending substantially across the width of the bladder; and
wherein the drive mechanism is operable to draw the pinch roller toward the top end of the interior cavity, thereby decreasing the volume of the flexible bladder.

2. The shaving apparatus of claim 1 further including a razor cartridge mounted thereon, the razor cartridge having at least one razor blade.

3. The shaving apparatus of claim 2, wherein the housing defines an aperture in which the razor cartridge is positioned.

4. The shaving apparatus of claim 1 further including a flowable shaving aid disposed in the flexible bladder.

5. The shaving apparatus of claim 1, wherein the support assembly includes at least one support post that extends at least partially into the interior cavity of the handle.

6. The shaving apparatus of claim 5, wherein the pinch roller is slidably mounted to at least one support post.

7. The shaving apparatus of claim 1, wherein the pinch roller has a curved surface.

8. The shaving apparatus of claim 7, wherein the pinch roller is cylindrical.

9. The shaving apparatus of claim 1, wherein the drive mechanism includes a rotatable shaft coupled to the pinch roller and a power spring operable to rotate the shaft in a first direction.

10. The shaving apparatus of claim 9, wherein a conveyor including a pulley and a belt couples the pinch roller to the shaft, the belt being looped around the shaft and the pulley; and
wherein the pinch roller is attached to the belt such that the belt is operable to move the pinch roller towards the top end of the interior cavity when the shaft is rotated in the first direction.

11. The shaving apparatus of claim 9, wherein a cord couples the pinch roller to the shaft, a first end of the cord being connected to the shaft, a second end of the cord being connected to the pinch roller; and
wherein the cord is operable to move the pinch roller towards the top end of the interior cavity when the shaft is rotated in the first direction.

12. The shaving apparatus of claim 11, wherein the cord is substantially flat.

13. The shaving apparatus of claim 9 further including a latch that is operable to selectively move between an open position and a closed position;
wherein the latch in the closed position is in engaged with the shaft and substantially prevents to shaft from rotating; and
wherein the latch in the open position is disengaged with the shaft and the shaft is rotatable.

14. The shaving apparatus of claim 13, wherein the latch and the shaft include complimentary ratchet mechanisms in order to allow the pinch roller to move incrementally towards the top end of the cavity.

15. The shaving apparatus of claim 13 further including depressable buttons coupled to the latch that are operable to move the latch between the open and closed positions.

16. The shaving apparatus of claim 1 further including a back plate positioned at least partially in the interior cavity such that at least a portion of the flexible bladder is in between the back plate and the pinch roller.

17. A replacement cartridge for a shaving apparatus, comprising:
a back plate;
a flexible bladder operable to store flowable shaving aid material;
a razor cartridge, the razor cartridge having at least one razor blade;
a housing having at least one port, the at least one port being adjacent the razor cartridge and in fluid communication with the contents of the flexible bladder.

18. The replacement cartridge of claim 19, wherein the housing defines an aperture in which the razor cartridge is positioned.

19. The replacement cartridge of claim 19 further including a flowable shaving aid disposed in the flexible bladder.

20. A shaving apparatus, comprising:
a handle including an interior cavity, an exterior grip portion, and an actuator, the actuator including a pinch roller, a support assembly and a drive mechanism;
a replacement cartridge at least partially inserted into the interior cavity of the handle, the replacement cartridge including a back plate, a flexible bladder having a width that is operable to store flowable shaving aid material, a razor cartridge having at least one razor blade, and a housing having at least one port, the at least one port being adjacent the razor cartridge and in fluid communication with the contents of the flexible bladder;
wherein the pinch roller being proximate to, and extending substantially across the width of the bladder; and
wherein the drive mechanism is operable to draw the pinch roller toward the top end of the interior cavity, thereby decreasing the volume of the flexible bladder and forcing shaving aid material from the flexible bladder.

21. The shaving apparatus of claim 22, wherein the housing defines an aperture in which the razor cartridge is positioned.

22. The shaving apparatus of claim 22 further including a flowable shaving aid disposed in the flexible bladder.

23. The shaving apparatus of claim 22, wherein the support assembly includes at least one support post that extends at least partially into the interior cavity of the handle.

24. The shaving apparatus of claim 25, wherein the pinch roller is slidably mounted to at least one support post.

25. The shaving apparatus of claim 22, wherein the pinch roller has a curved surface.

26. The shaving apparatus of claim 22, wherein the pinch roller is cylindrical.

27. The shaving apparatus of claim 22, wherein the drive mechanism includes a rotatable shaft coupled to the pinch roller and a power spring operable to rotate the shaft in a first direction.

28. The shaving apparatus of claim 29, wherein a conveyor including a pulley and a belt couples the pinch roller to the shaft, the belt being looped around the shaft and the pulley; and
wherein the pinch roller is attached to the belt such that the belt is operable to move the pinch roller towards the top end of the interior cavity when the shaft is rotated in the first direction.

29. The shaving apparatus of claim 29, wherein a cord couples the pinch roller to the shaft, a first end of the cord being connected to the shaft, a second end of the cord being connected to the pinch roller; and
wherein the cord is operable to move the pinch roller towards the top end of the interior cavity when the shaft is rotated in the first direction.

30. The shaving apparatus of claim 31, wherein the cord is substantially flat.

31. The shaving apparatus of claim 22 further including a latch that is operable to selectively move between an open position and a closed position;
wherein the latch in the closed position is in engaged with the shaft and substantially prevents to shaft from rotating; and
wherein the latch in the open position is disengaged with the shaft and the shaft is rotatable.

32. The shaving apparatus of claim 33, wherein the latch and the shaft include complimentary ratchet mechanisms in order to allow the pinch roller to move incrementally towards the top end of the cavity.

33. The shaving apparatus of claim 33 further including depressable buttons coupled to the latch that are operable to move the latch between the open and closed positions.

34. The shaving apparatus of claim 22 further including a back plate positioned at least partially in the interior cavity such that at least a portion of the flexible bladder is in between the back plate and the pinch roller.
